(19) United States
(12) Patent Application Publication
(10) Pub. No.: US 2023/0195037 A1
(43) Pub. Date: Jun. 22, 2023

(54) WATCH CASE WITH ROTATING BEZEL

(71) Applicant: Montres Breguet S.A., L'Abbaye (CH)

(72) Inventors: René PIGUET, Cheseaux-sur-Lausanne (CH); Marc STRANCZL, Nyon (CH); Adrien CHAPPUIS, L'Isle (CH)

(73) Assignee: Montres Breguet S.A., L'Abbaye (CH)

(21) Appl. No.: 17/973,343

(22) Filed: Oct. 25, 2022

(30) Foreign Application Priority Data
Dec. 21, 2021 (EP) 21216432.1

(51) Int. Cl. G04B 19/28; C22C 9/04; C22C 9/01; C22C 19/00; C22C 14/00

(52) U.S. Cl. CPC G04B 19/283; C22C 9/04; C22C 9/01; C22C 19/007; C22C 14/00

(57) ABSTRACT

A watch case (6) including a rotating bezel (1), a middle (3) and a connecting spring (2) between the rotating bezel (1) and the middle (3), the connecting spring (2) being accommodated within a first groove (7) formed in an external wall (3a) of the middle (3) and within a second groove (8) formed in an internal wall (1 a) of the rotating bezel (1), the first and second grooves (7,8) being preferably arranged opposite one another. The connecting spring (2) is made of an alloy with memory of shape.

### CROSS REFERENCE TO RELATED APPLICATIONS

This application is Non-Provisional Application, claiming priority based on European Patent Application No. 21216432.1 filed Dec. 21, 2021.

### TECHNICAL FIELD OF THE INVENTION

The present invention relates to a watch case provided with a rotating bezel, and more specifically to the nature of the spring connecting the middle to the rotating bezel.

### Technological Background

It is known to mount a rotating bezel on a middle via a polygonal spring fitted simultaneously into grooves of the bezel and of the middle. The spring holds the bezel in position in the vertical direction while leaving it with one rotational degree of freedom. This polygonal spring has the advantage of being a low-cost assembly solution and enables the dismount of the bezel subject to a relatively large dismount force.

This spring is formed by a generally metallic wire which is subjected to deformations upon assembly thereof within the grooves of the middle and of the rotating bezel. These deformations could be considerable and lead to a plastic deformation of the wire.

In this respect, FIGS. 3 to 5 schematise the method of assembling the bezel 1 and the spring 2 on the middle 3. At the beginning of the assembly schematised in FIG. 3, the spring 2 is positioned against the inclined plane 3c of the middle 3 and is accommodated within the groove 8 of the bezel 1. During this assembly sequence, the spring is not loaded. Afterwards, in the assembly sequence of FIG. 4, the spring 2 is positioned against the vertical wall 3b following the inclined wall 3c of the middle 3. It is then strongly loaded radially before being relieved upon accommodation thereof within the grooves 7,8 of the middle 3 and of the bezel 1 intended for operation thereof (FIG. 5). The applied strains and the corresponding stresses in the sequence of FIG. 4 vary from one part to another depending on the manufacturing tolerances. In some products, this stress is critical because it plastically deforms the spring. This implies that the repeatability of the frictional torque upon rotation of the bezel and the force necessary for dismount are variable from one part to another. These plastic deformations modify the frictional torque between the bezel and the middle and therefore the sensory feeling perceived by the client, which is a major disadvantage.

### SUMMARY OF THE INVENTION

An object of the invention is to overcome the aforementioned disadvantage by providing a spring made of a material that could be subjected to considerable stresses without being plastically deformed. More specifically, the spring is made of an alloy with memory of shape exploited for its superelasticity properties. These materials allow for a wide range of strain without any residual plastic deformation thanks to a phase transformation phenomenon. It follows that despite the high stresses and the large strains upon insertion of the spring during the assembly, the torque perceived by the user is more repeatable and independent of the geometry upon insertion of the spring. Thus, the invention allows reducing the dimensions of the bezels by geometries of grooves that would be critical with conventional constructions and materials while preserving a stable felt torque.

More specifically, the present invention relates to a watch case comprising a rotating bezel, a middle and a connecting spring between the rotating bezel and the middle, said connecting spring being accommodated within a first groove formed in an external wall of the middle and within a second groove formed in an internal wall of the rotating bezel, said first and second grooves being preferably arranged opposite one another, the watch case being characterised in that the connecting spring is made of an alloy with memory of shape.

Preferably, the alloy with memory of shape is a copper-based alloy, a nickel and titanium based alloy, a nickel-based alloy or an iron-based alloy.

Other features and advantages of the invention will appear upon reading the following detailed description, with reference to the appended drawings.

### BRIEF DESCRIPTION OF THE FIGURES

FIG. 1 represents a watch case provided with the connecting spring according to the invention.

FIG. 2 represents the connecting spring used in the watch case according to the invention.

FIGS. 3 to 5 represent the sequences of assembling the spring within the grooves of the middle and of the bezel according to the prior art.

FIG. 6 represents the stress-strain curve of an alloy with memory of shape.

FIG. 7 represents an alternative to the connecting spring of FIG. 2.

### DETAILED DESCRIPTION OF THE INVENTION

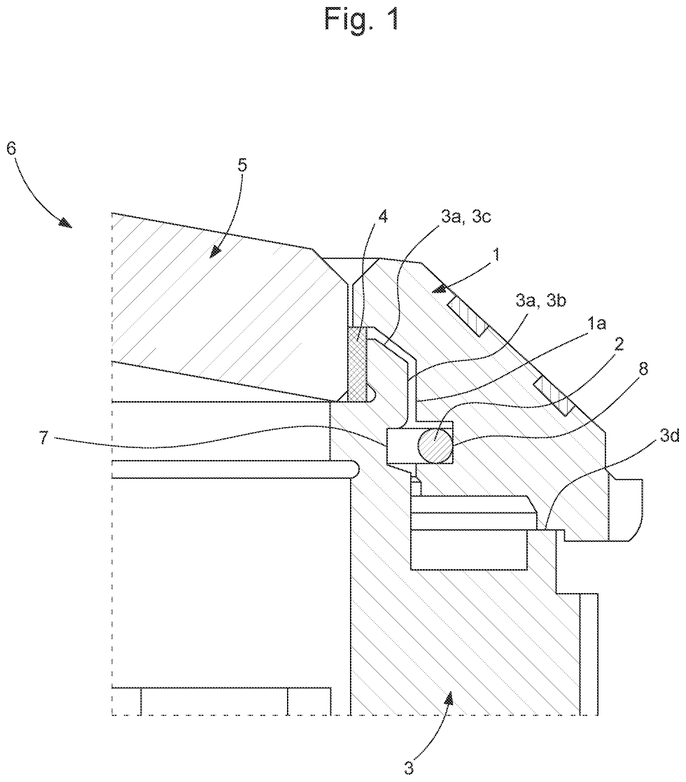

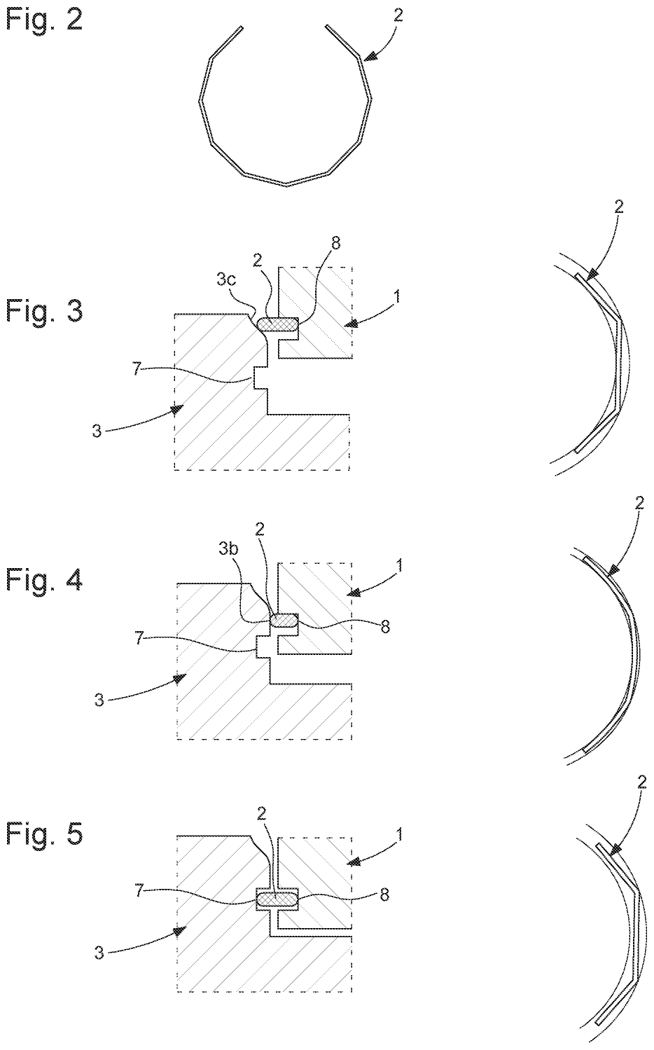

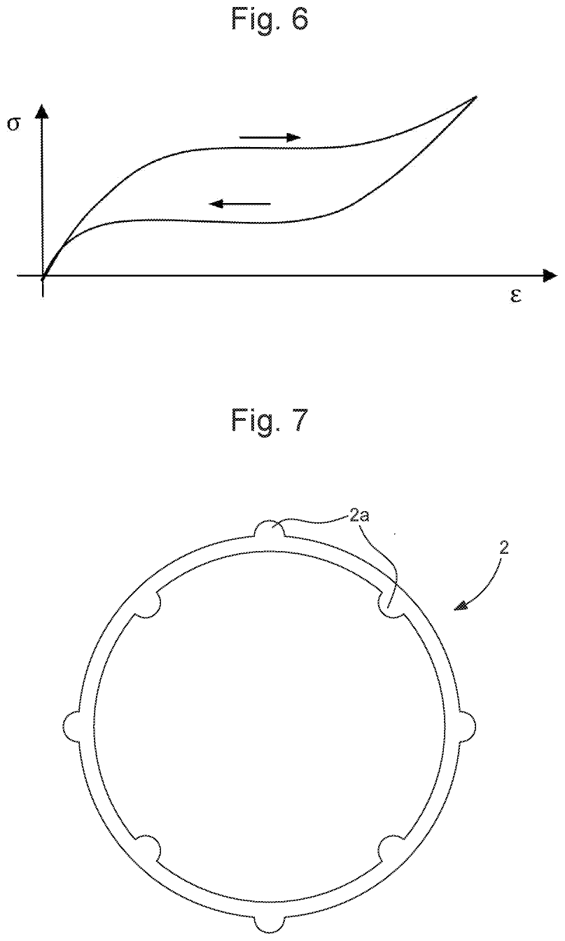

The watch case 6 includes a rotating bezel 1 mounted on the middle 3 (FIG. 1). The middle 3 and the rotating bezel 1 respectively include a groove 7 and a groove 8. The groove 7 is formed in the external wall 3a of the middle 3 and the groove 8 is formed in the internal wall 1a of the rotating bezel 1. Preferably, the grooves 7 and 8 are arranged opposite one another and serve as a housing for the connecting spring 2 according to the invention. Thanks to this spring 2, the rotating bezel 1 is pressed downwards against a shoulder 3d of the middle 3. As represented in FIG. 2, the connecting spring may have a polygonal shape. According to a variant represented in FIG. 7, the connecting spring may have an annular shape with circular protrusions 2a alternately disposed over the internal face and over the external face of the ring. Other shapes could also be considered without departing from the scope of the invention.

The connecting spring is made of an alloy with memory of shape. FIG. 6 illustrates the superelastic behaviour of an alloy with memory of shape which has an austenitic structure at room temperature which is transformed into martensite by the application of a stress, which allows deforming the material reversibly by several percents. The tensile curve has at first an elastic linear behaviour up to a critical stress where the martensitic transformation induces a superelastic behaviour with a deformation increasing under an almost constant stress. This is the level that is observed In FIG. 6. As soon as the stress is relieved, the reverse transformation from martensite into austenite is done and the alloy recovers its first dimension.

Preferably, the alloy with memory of shape is a nickel and titanium based alloy. This alloy is completely biocompatible and very corrosion-resistant. The nickel and titanium based alloy consists in weight of nickel with a percentage comprised between 52.5 and 63%, of titanium with a percentage comprised between 36.5 and 47% and of possible impurities with a percentage lower than or equal to 0.5%. Advantageously, it could consist of an alloy including 55.8% of titanium, 44% of nickel and of the possible impurities with a level lower than or equal to 0.2% by weight.

It could also consist of a copper-based alloy. More specifically, the copper-based alloy is one of the alloys having the following composition in weight with a percentage of possible impurities lower than or equal to 0.5%:
Cu between 64.5 and 85.5%, Zn between 9.5 and 25% and Al between 4.5 and 10%,
Cu between 79.5 and 84.5%, Al between 12.5 and 14% and Ni between 2.5 and 6%,
Cu between 87 and 88.2%, Al between 11 and 12% and Be between 0.3 and 0.7%,
   for a total percentage of 100%.

It could also consist of an iron-based alloy, for example a Fe—Mn—Si alloy. It could also consist of a titanium-free nickel-based alloy.

These alloys have an austenitic microstructure, at room temperature, in the absence of stresses.

1. A watch case (6) comprising a rotating bezel (1), a middle (3) and a connecting spring (2) between the rotating bezel (1) and the middle (3), said connecting spring (2) being accommodated within a first groove (7) formed in an external wall (3a) of the middle (3) and within a second groove (8) formed in an internal wall (1a) of the rotating bezel (1), wherein the connecting spring (2) is made of an alloy with memory of shape.

2. The watch case (6) according to claim 1, wherein the alloy with memory of shape is a copper-based alloy, a nickel-based alloy, a nickel and titanium based alloy or an iron-based alloy.

3. The watch case (6) according to claim 1, wherein the nickel and titanium based alloy consists in weight of nickel with a percentage comprised between 52.5 and 63%, of titanium with a percentage comprised between 36.5 and 47% and of possible impurities with a percentage lower than or equal to 0.5%.

4. The watch case (6) according to claim 2, wherein the copper-based alloy is one of the alloys having the following composition in weight with a percentage of possible impurities lower than or equal to 0.5%:
Cu between 64.5 and 85.5%, Zn between 9.5 and 25% and Al between 4.5 and 10%,
Cu between 79.5 and 84.5%, Al between 12.5 and 14% and Ni between 2.5 and 6%,
Cu between 87 and 88.2%, Al between 11 and 12% and Be between 0.3 and 0.7%.

5. The watch case (6) according to claim 1, wherein the connecting spring (2) has a polygonal shape.

6. The watch case (6) according to claim 1, wherein the connecting spring (2) has an annular shape with circular protrusions alternately disposed over the internal face and over the external face of the ring.

7. The watch case (6) according to claim 1, wherein said first and second grooves (7, 8) are arranged opposite one another.
